(19) United States
(12) Patent Application Publication
(10) Pub. No.: US 2020/0005021 A1
(43) Pub. Date: Jan. 2, 2020

(54) FACE DETECTION DEVICE, CONTROL METHOD THEREOF, AND PROGRAM

(71) Applicant: Omron Corporation, Kyoto (JP)

(72) Inventors: Masahiro Akagi, Shiga (JP); Hiroaki Terai, Shiga (JP); Shinji Endo, Kyoto (JP)

(73) Assignee: Omron Corporation, Kyoto (JP)

(21) Appl. No.: 16/467,706

(22) PCT Filed: Nov. 28, 2017
(86) PCT No.: PCT/JP2017/042514

§ 371 Date: Jun. 7, 2019

(30) Foreign Application Priority Data
Mar. 1, 2017 (JP) 2017-038616

(51) Int. Cl. G06K 9/00; G06K 9/46; G06T 7/11; H04N 5/235

(52) U.S. Cl. CPC G06K 9/00228; G06K 9/4661; G06T 2207/30201; H04N 5/2351; G06T 7/11

(57) ABSTRACT

A face detection device has a classifier configured to determine, while scanning an image with a search window, whether a partial image in the search window is a face image with use of an image feature based on a difference in luminance between local regions in the partial image. The face detection device determines whether the partial image in the search window is a low-luminance image, and performs determination by the classifier with use of a changed partial image obtained by changing a luminance of a pixel in a predetermined position in the partial image instead of the partial image when determined that the partial image is a low-luminance image.

### TECHNICAL FIELD

The present invention relates to a face detection device that detects a face from an image.

### BACKGROUND ART

In recent years, a face detection technology that automatically detects a face from an image is implemented in various applications, including auto focus of a digital camera and a monitoring camera. One of the most practical algorithms of the face detection technology is a method of evaluating the likeliness of the image being a face on the basis of the difference in luminance between the local regions. In the face image, there is a tendency in which the region of the eyes is darker than the regions of the nose and cheeks, the region of the mouth is darker than the region of the chin, and the region of the forehead is brighter than the region of the eyes, for example, and the tendency as above is common regardless of sex or race. By focusing on the tendency, whether the image is a face or a non-face is determined with use of the image feature based on the difference in luminance between the local regions. The Haar-like feature is often used as the image feature.

However, in an algorithm using the difference in luminance between the local regions, it is likely that the success rate of the face detection decreases when the input image is an overall dark image or is an image photographed against the sun. This is because the image feature of the face cannot be extracted well for the dark image or the backlit image because the difference in luminance between the local regions is small or the brightness relationship between the local regions is reversed (for example, the region of the eyes becomes brighter than the region of the nose in some cases). In PTL 1, a method for improving the face detection accuracy by performing the face detection after increasing the luminance of an input image by gamma correction when the luminance of the input image is low is proposed. Although the method in PTL 1 is very effective, the method is not for all purposes. In particular, for an image in which the difference in luminance between the local regions is extremely small and an image in which the brightness relationship is reversed, the success rate of the face detection cannot be expected to improve with the method using the gamma correction.

### CITATION LIST

### Patent Literature

PTL 1: Japanese Patent Application Publication No. 2016-167681

### SUMMARY OF INVENTION

### Technical Problem

The present invention has been made in view of the above-mentioned situation, and an object thereof is to provide a technique for improving the success rate of face detection for a dark image or an image in which the brightness relationship is reversed.

### Solution to Problem

In order to attain the above-mentioned object, the present invention employs a method of performing the face detection for the dark image or the image in which the brightness relationship is reversed with use of an image in which the luminance of pixels in predetermined positions in the image is changed (reduced/increased).

More specifically, a first aspect of the present invention provides a face detection device including: a classifier configured to determine, while scanning an image with a search window, whether a partial image in the search window is a face image with use of an image feature based on a difference in luminance between local regions in the partial image; and a low-luminance image determination unit configured to determine whether the partial image in the search window is a low-luminance image, wherein determination by the classifier is performed with use of a changed partial image obtained by changing a luminance of a pixel in a predetermined position in the partial image instead of the partial image when the low-luminance image determination unit determines that the partial image is a low-luminance image.

The predetermined position may be a region to be relatively dark in a face image, and the changed partial image may be an image obtained by changing the luminance of the pixel in the predetermined position to a small value. The predetermined position may be a position of an eye assuming that the partial image is a face image. The changed partial image may be an image obtained by replacing the luminance of the pixel in the predetermined position in the partial image with a predetermined value. The predetermined value may be a minimum luminance value.

According to the above-mentioned configuration, when the partial image in the search window is a low-luminance image, face detection (face/non-face determination by the classifier) is performed using the changed partial image instead of the partial image, and hence the success rate of the face detection can be improved for a dark image or an image in which the brightness relationship is reversed as compared to the method of the conventional art. The configuration of the present invention is simple and can use the same classifier for normal processing (when the image is not a low-luminance image), and hence has an advantage in that implementation to existing face detection devices is easy.

Note that the present invention can be understood as a face detection device including at least a part of the configurations and the functions described above. The present invention can also be understood as a control method of the face detection device or a face detection method including at least a part of the above-mentioned processing, a program for causing a computer to execute those methods, or a computer-readable recording medium that non-transitorily records the program as above therein. The present invention can be configured by combining the configurations and the processing described above as much as possible as long as there are no technical contradictions.

### Advantageous Effects of Invention

According to the present invention, the success rate of the face detection can be improved for the dark image and the image in which the brightness relationship is reversed.

### BRIEF DESCRIPTION OF DRAWINGS

FIG. 1 illustrates a block diagram illustrating a functional configuration of a face detection device.

FIG. 2 illustrates a flowchart of face detection processing.

FIG. 3 illustrates an example of images.

FIG. 4A to FIG. 4C each illustrate views for describing the effect of low-luminance processing.

### DESCRIPTION OF EMBODIMENTS

The present invention relates to a face detection algorithm for automatically detecting a face from an image. The present invention can be used as an elemental technology in image sensing, computer vision, robot vision, and the like. As specific applications, the present invention can be applied to various fields such as detection and tracking of a person by a monitoring camera, auto focus by a digital camera or a camera built in a smartphone, detection of a person by home appliances, and a face detection engine in a face recognition system.

An example of a preferred embodiment for performing the present invention is described below with reference to the drawings. Note that the configuration and the operation of a device described in the embodiment below are examples, and it is not intended to limit the scope of the present invention only thereto.

(Configuration of Face Detection Device)

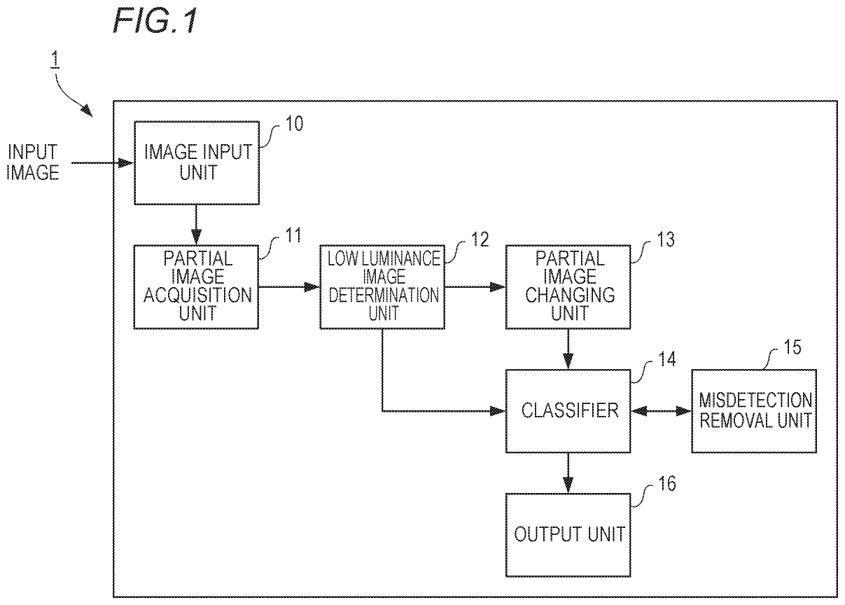

The configuration of a face detection device according to an embodiment of the present invention is described with reference to FIG. 1. FIG. 1 is a block diagram schematically illustrating the functional configuration of the face detection device 1.

The face detection device 1 includes an image input unit 10, a partial image acquisition unit 11, a low-luminance image determination unit 12, a partial image changing unit 13, a classifier 14, a misdetection removal unit 15, and an output unit 16 as main functions. The face detection device 1 can be formed by a general purpose computer including a CPU (processor), a memory, a storage (an HDD, an SSD, and the like), an input device (a keyboard, a mouse, a touch panel, and the like), an output device (a display and the like), and a communication interface, for example. In this case, the functions illustrated in FIG. 1 are implemented when the CPU executes a program stored in the storage or the memory. However, a specific configuration of the face detection device 1 is not limited to the example. For example, distributed computing may be performed by a plurality of computers, or a part of the functions may be executed by a cloud server. Alternatively, the entire face detection device 1 or a part of the functions thereof may be formed by circuits such as an ASIC or an FPGA.

The image input unit 10 serves as a function of acquiring an image (hereinafter referred to as an “input image”) to be processed by an external device. As the external device, an image pickup device such as a digital camera and a digital video camera, a storage device that stores image data therein, other computers including an image pickup device or a storage device, and the like are assumed. The input image may be a monochrome image or a color image, and the image format is not particularly limited.

The partial image acquisition unit 11 serves as a function of scanning the input image with a search window. The search window is a frame indicating a partial area (a partial image submitted for processing of determining whether the image is a face or a non-face) in the input image. The partial image acquisition unit 11 inputs the partial image in each position to the low-luminance image determination unit 12 and the classifier 14 in the later stage while moving the position of the search window by one pixel at a time, for example. When the size of the face included in the image is not determined, a face of any size can be detected by repeating the scanning and the face/non-face determination while changing the size of the search window and/or the resolution of the input image.

The low-luminance image determination unit 12 serves as a function of determining whether the partial image (or the entire input image) is a low-luminance image. A determination method of the low-luminance image can be any method. For example, a representative value (an average value, an intermediate value, a mode value, a maximum value, or the like) of the luminance in the partial image may be calculated, and the partial image may be determined to be a low-luminance image when the representative value is smaller than a predetermined threshold value. Alternatively, photographing conditions (for example, the brightness of the object measured by an illuminance sensor, exposure settings, or the like) when the input image is photographed may be acquired with the input image, and it may be determined whether the input image is a low-luminance image on the basis of the photographing conditions.

The partial image changing unit 13 serves as a function of changing the luminance of some pixels of the partial image when the partial image is a low-luminance image. Detailed processing is described below.

The classifier 14 serves as a function of performing face/non-face determination that determines whether the partial image is an image of a face with use of an image feature based on the difference in luminance between the local regions in the partial image. In this embodiment, the Haar-like feature is used as the image feature, and a cascade structure classifier formed by a plurality of weak classifiers is used. However, the configuration of the classifier 14 and the used image feature are not limited to the above, and may be any configuration and image feature.

The misdetection removal unit 15 serves as a function for removing misdetection of the classifier 14 by performing face/non-face determination by a simple determination logic different from the classifier 14 for the partial image determined to be a “face” by the classifier 14. The detailed determination logic is described below.

The output unit 16 serves as a function of outputting the result of the face detection. The output result includes the number of faces detected from the input image, and the position, the size, the orientation of the detected face, for example.

(Face Detection Processing)

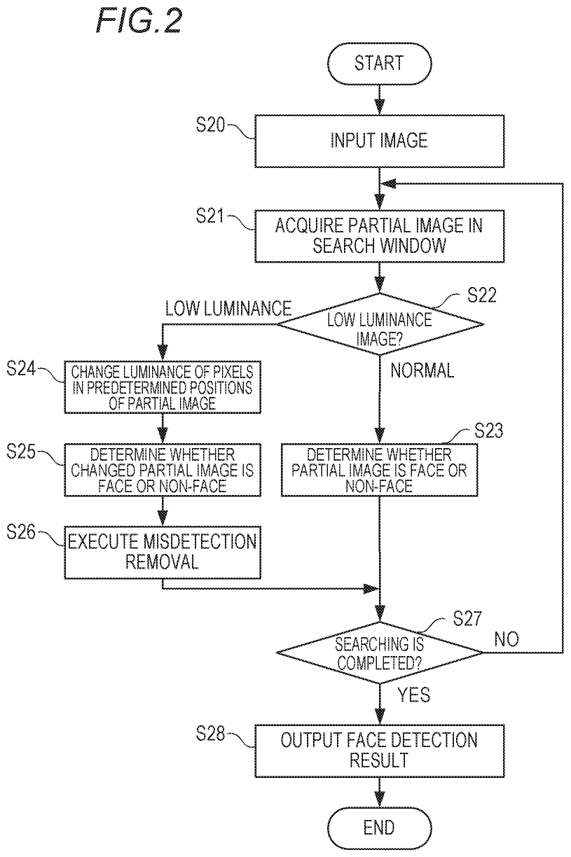

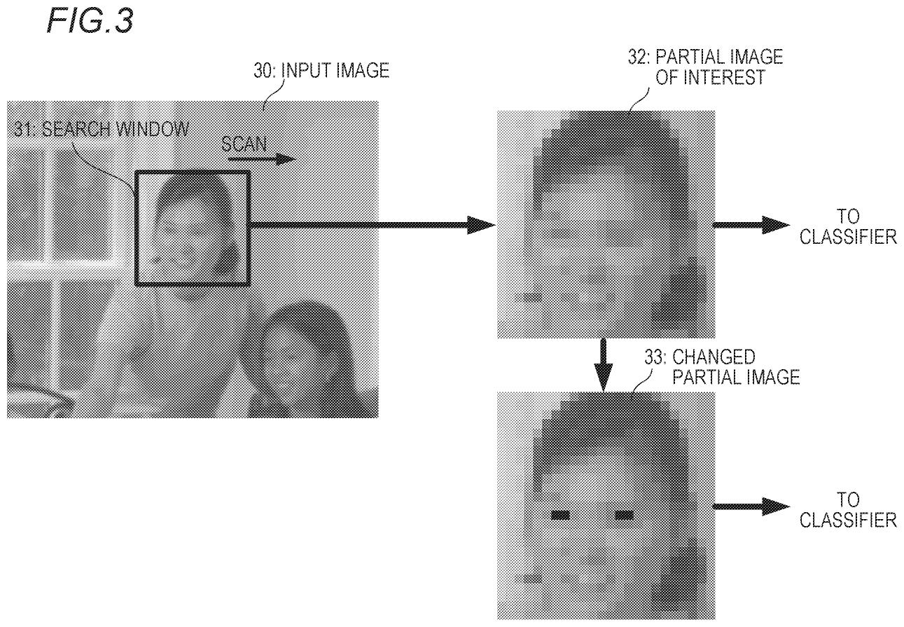

Face detection processing performed by the face detection device 1 of this embodiment is described with reference to FIG. 2 and FIG. 3. FIG. 2 is a flowchart of the face detection processing, and FIG. 3 is an example of images.

In Step S20, the image input unit 10 acquires an input image 30 from the external device. In Step S21, the partial image acquisition unit 11 sets a search window 31 for the input image 30, and acquires a partial image 32 in the search window 31. The partial image 32 acquired in Step S21 is referred to as a “partial image 32 of interest” in the description below.

In Step S22, the low-luminance image determination unit 12 determines whether the partial image 32 of interest is a low-luminance image. The low-luminance image determination unit 12 of this embodiment calculates an average value of the luminance in the partial image 32 of interest, and determines that the partial image 32 of interest is a low-luminance image when the average value is smaller than a threshold value. According to the determination logic as above, when the environment of the input image 30 at the time of photographing is dark, when exposure at the time of the photographing is not sufficient, or when the image is photographed against the sun, for example, the object (that is, the face of the person) appears dark, and hence it is determined that the image is a low-luminance image.

When it is determined that the partial image 32 of interest is not a low-luminance image in Step S22, the processing proceeds to Step S23, and the partial image 32 of interest is input to the classifier 14. The classifier 14 extracts a plurality of predetermined types of Haar-like features from the partial image 32 of interest, and determines whether the partial image 32 of interest is a face image on the basis of the values of the image features.

Meanwhile, when it is determined that the partial image 32 of interest is a low-luminance image in Step S22, the processing proceeds to exceptional processing (low-luminance processing) as below. In Step S24, the partial image changing unit 13 changes the luminance of the pixels in predetermined positions of the partial image 32 of interest. More specifically, as shown in FIG. 3, the luminance of a plurality of number of pixels corresponding to the positions of eyes when it is assumed that the partial image 32 of interest is a face image is replaced with a predetermined value. The “predetermined value” only needs to be a sufficiently small (low-luminance) value, and is the minimum value (for example, 0 when the luminance value of the image has a value range of from 0 (dark) to 255 (bright)) of the luminance in this embodiment. The partial image 32 of interest after the luminance change is input to the classifier 14 as a changed partial image 33. In Step S25, the classifier 14 extracts a plurality of predetermined types of Haar-like features from the changed partial image 33, and determines whether the changed partial image 33 is a face image on the basis of the values of the image features. The processing in Step S25 is basically the same as the processing in Step S23 (that is, the used image features, classifiers, and the like are the same, and the only difference between Step S25 and Step S23 is the feature in which some pixels of the partial image is changed).

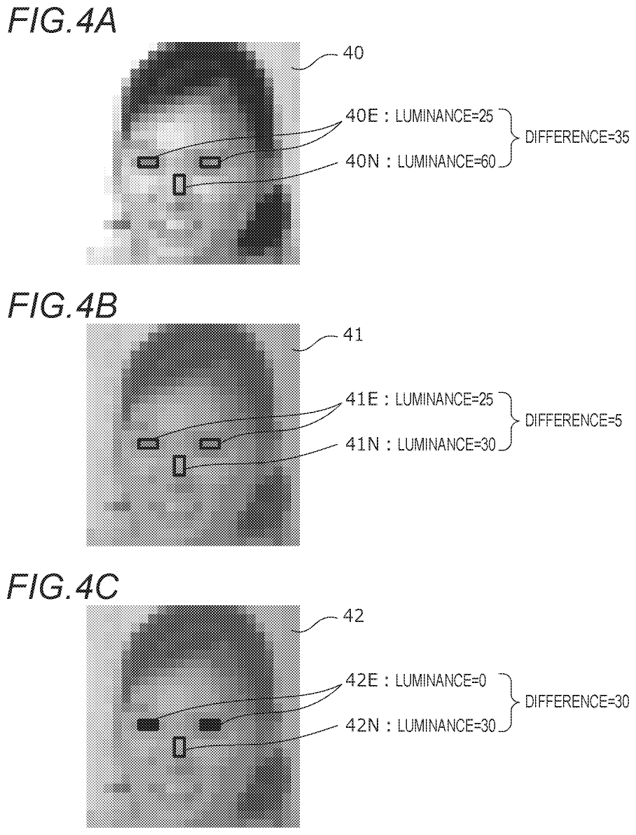

The effect of the low-luminance processing is described with reference to FIG. 4A to FIG. 4C. FIG. 4A shows an example of the image features extracted from a partial image 40 that is not a low-luminance image, and FIG. 4B shows an example of the image features extracted from a partial image 41 that is a low-luminance image. In the partial image 40 in FIG. 4A, the luminance of a region 40E of the eyes is 25, the luminance of a region 40N of the nose is 60, and the difference in luminance between the region 40E of the eyes and the region 40N of the nose is 35, and hence a distinct image feature can be extracted. However, in the partial image 41 of FIG. 4B, the image is overall dark, the luminance of a region 41E of the eyes is 25, the luminance of a region 41N of the nose is 30, and the difference in luminance between the two regions 41E and 41N is 5 and is extremely small. Therefore, the possibility of the face detection failing is high when the partial image 41 in FIG. 4B is directly input to the classifier 14.

FIG. 4C shows an example of the image features extracted from a changed partial image 42. The changed partial image 42 is an image in which the luminance of the pixels of the region 41E of the eyes of the partial image 41 in FIG. 4B is set to 0. Therefore, in the changed partial image 42, the luminance of region 42E of the eyes is 0, the luminance of a region 42N of the nose is 30, and the difference in luminance between the two regions 42E and 42N is 30. Therefore, it can be understood that a distinct image feature can be extracted.

As described above, in the low-luminance processing of this embodiment, the difference in luminance between the regions distinctly appears even in a low-luminance image by mandatorily reducing the luminance of the regions (for example, the region of the eyes, the region of the mouth, and the region of the eye brows) to be relatively dark in the face. Even when the brightness is reversed, the brightness relationship can be returned to a normal state by mandatorily setting the luminance of the regions to be originally dark to the minimum value (for example, even when the brightness is reversed such that the luminance of the region of the eyes is 35 and the luminance of the region of the nose is 25, an image feature in which the region of the nose is brighter than the region of the eyes and the difference in luminance is 25 can be acquired by changing the luminance of the region of the eyes to 0). Therefore, for the low-luminance image, by providing the changed partial image 42 to the classifier 14 (instead of the partial image 41), the success rate of the face detection is expected to improve.

Incidentally, while the above-mentioned low-luminance processing has an advantage in that the success rate of the face detection can be improved for a dark image or an image in which the brightness relationship is reversed, the above-mentioned low-luminance processing also has a disadvantage in that the possibility of misdetection (to determine a non-face image as a face) may increase because the face/non-face determination is performed by ignoring image information on a part (the part of the eyes in the example in FIG. 4C) of the input image. Thus, in this embodiment, a simple misdetection removal is performed by the misdetection removal unit 15 for the low-luminance processing.

More specifically, for the partial image determined to be a “face” in Step S25 in FIG. 2, the misdetection removal unit 15 performs the face/non-face determination by a determination logic different from the classifier 14, and discards the face detection result in Step S25 when it is determined that the image is a “non-face” (Step S26). Any logic may be used as the determination logic of the misdetection removal unit 15, but a logic, which is as simple as possible and of which calculation amount is as small as possible, is desired in order to increase the speed of the processing. Examples of the determination logic are listed below.

(1) When the number of pixels of which luminance difference from an adjacent pixel is larger than a predetermined value is out of a predetermined range in a partial image, it is determined that the image is a “non-face”.

(2) When the number of pixels that are darker or brighter than any of four adjacent pixels is out of a predetermined range in a partial image, it is determined that the image is a “non-face”.

(3) When the number of pixels that are extremely bright is equal to or more than a predetermined number in a partial image, it is determined that the image is a “non-face”. This is because the face part becomes overall dark and sections that are extremely bright such as blown out highlights are not included in the face image when the image is photographed in lighting conditions with low luminance or against the sun. For example, when the number of pixels of which luminance value exceeds 185 is equal to or more than 10% of the entire partial image, it may be determined that the image is a “non-face”.

(4) When the luminance of the eye region is larger (brighter) than the luminance of the nose region in a partial image, it is determined that the image is a “non-face”.

(5) When the luminance of the mouth region in a partial image is larger (brighter) than the luminance of the nose region, it is determined that the image is a “non-face”.

(6) When the luminance of the mouth region in a partial image is larger (brighter) than the luminance of a region around the mouth, it is determined that the image is a “non-face”.

(7) When the luminance of the eye region in the partial image is larger (brighter) than the luminance of the region between the left and right eyes, it is determined that the image is a “non-face”.

The misdetection removal may be performed by only one determination logic out of the logics (1) to (7) described above, or the misdetection removal may be performed with use of two or more determination logics.

In Step S27, it is determined whether the searching of the input image is completed. When the searching is not completed, the processing returns to Step S21. After the search window 31 is moved to the next position, the processing of Step S22 and steps thereafter is repeated. After the searching of the entire input image is completed, the output unit 16 outputs the result of the face detection in Step S28, and the face detection processing is ended.

According to the face detection of this embodiment described above, low-luminance processing is performed for a dark image or an image in which the brightness relationship is reversed, and hence the success rate of the face detection can be improved for the dark image and the image in which the brightness relationship is reversed as compared to the method of the conventional art. When the low-luminance processing is performed, misdetection due to the low-luminance processing is removed by performing misdetection removal by a determination logic different from the classifier 14, and hence improvement in overall determination accuracy can also be expected. In addition, the low-luminance processing of this embodiment is a simple method in which the luminance of some pixels of a partial image is replaced with a predetermined value, and the same classifier 14 for normal processing can be used. Therefore, the low-luminance processing of this embodiment has an advantage in that additional implementation to existing face detection devices is easy.

<Others>

The description of the above-mentioned embodiment is merely for exemplarily describing the present invention. The present invention is not limited to the specific modes above, and various modifications can be made within the scope of the technical concept. For example, in the above-mentioned embodiment, the luminance of the pixels of the eye region in the partial image is replaced with a minimum value, but the method of the low-luminance processing is not limited thereto. As the regions to be relatively dark in the face image, there are the mouth region, the eye brow region, and the like other than the eye region, and the luminance of those regions may be mandatorily reduced. The luminance after the replacement does not necessarily need to be a minimum value, and only needs to be a sufficiently small value. A similar effect can also be obtained by mandatorily increasing the luminance of the regions (the nose region, the chin region, the forehead region, and the like) to be relatively bright in the face image.

### REFERENCE SIGNS LIST

1: Face detection device
10: Image input unit, 11: Partial image acquisition unit, 12: Low luminance image determination unit, 13: Partial image changing unit, 14: Classifier, 15: Misdetection removal unit, 16: Output unit
30: Input image, 31: Search window, 32: Partial image of interest, 33: Changed partial image
40: Partial image that is not low-luminance image, 40E: Eye region, 40N: Nose region
41: Partial image that is low-luminance image, 41E: Eye region, 41N: Nose region
42: Changed partial image, 42E: Eye region, 42N: Nose region

1. A face detection device, comprising:
a classifier configured to determine, while scanning an image with a search window, whether a partial image in the search window is a face image with use of an image feature based on a difference in luminance between local regions in the partial image; and
a low-luminance image determination unit configured to determine whether the partial image in the search window is a low-luminance image, wherein
determination by the classifier is performed with use of a changed partial image obtained by changing a luminance of a pixel in a predetermined position in the partial image instead of the partial image when the low-luminance image determination unit determines that the partial image is a low-luminance image.

2. The face detection device according to claim 1, wherein:
the predetermined position is a region to be relatively dark in a face image; and
the changed partial image is an image obtained by changing the luminance of the pixel in the predetermined position to a small value.

3. The face detection device according to claim 1, wherein the predetermined position is a position of an eye assuming that the partial image is a face image.

4. The face detection device according to claim 1, wherein the changed partial image is an image obtained by replacing the luminance of the pixel in the predetermined position in the partial image with a predetermined value.

5. The face detection device according to claim 4, wherein the predetermined value is a minimum luminance value.

6. A control method of a face detection device, the face detection device including a classifier configured to determine, while scanning an image with a search window, whether a partial image in the search window is a face image with use of an image feature based on a difference in luminance between local regions in the partial image, the control method comprising:
a step of determining whether the partial image in the search window is a low-luminance image; and
a step of performing determination by the classifier with use of a changed partial image obtained by changing a luminance of a pixel in a predetermined position in the partial image instead of the partial image when it is determined that the partial image is a low-luminance image.

7. A non-transitory computer-readable medium storing a program for causing a computer to execute each step of the control method of the face detection device according to claim 6.
